(19) United States
(12) Patent Application Publication
(10) Pub. No.: US 2022/0355671 A1
(43) Pub. Date: Nov. 10, 2022

(54) Systems and Methods for Braking an Electric Vehicle

(71) Applicant: Atlis Motor Vehicles, Inc., Mesa, AZ (US)

(72) Inventors: Mark Hanchett, Mesa, AZ (US); Mohammad Kia, Peoria, AZ (US); Dustin Booth, Peoria, AZ (US); Derek Duff, Bradley, ME (US)

(73) Assignee: Atlis Motor Vehicles, Inc., Mesa, AZ (US)

(21) Appl. No.: 17/869,010

(22) Filed: Jul. 20, 2022

Related U.S. Application Data
(60) Provisional application No. 63/224,000, filed on Jul. 21, 2021.

(51) Int. Cl. B60L 7/26; B60T 8/32; B60T 8/1761; B60T 8/171

(52) U.S. Cl. CPC B60L 7/26; B60T 8/3215; B60T 8/17616; B60T 8/171; B60T 2240/00; B60T 2250/04; B60T 2270/604; B60T 2270/602; B60T 2270/10

(57) ABSTRACT

A braking system that uses a combination of a friction brake force and a traction motor brake force to slow or stop the rotation of the wheel. A friction brake may provide the friction brake force. A traction motor may provide the traction motor brake force. The braking system may include sensors that provide data for determining a wheel lock threshold for each wheel. The friction brake force and the traction motor brake force may be adjusted for each wheel to provide an applied brake force to the wheel that is less than or equal to the wheel lock threshold.

### BACKGROUND

Embodiments of the present invention relate to braking systems for electric vehicles.

Current automobiles that use disc brakes (e.g., friction brakes) use anti-lock braking systems to keep the wheels from locking up and sliding on the road. Current anti-lock brake systems use sensors to detect when the wheels locked up. When a wheel locks up, the brake is momentarily released so that the wheel may start turning again.

Electric vehicles may benefit from using a braking force that is a combination of friction brakes and braking using the traction motor. The combined brake force may be adjusted to keep the force just below the threshold at which the wheels lock up.

### SUMMARY

The braking force applied to the wheels of an electric vehicle may be a combination of the force provided by friction brakes (e.g., disc brakes) and braking using the traction motor. A traction motor may provide a braking force by operating the motor as a generator (e.g., regenerative braking) or by applying a voltage, or providing a current, that causes the traction motor to rotate in a direction opposite from its current direction of rotation (e.g., reverse load).

Sensors may be used to detect or predict when the wheels of the electric vehicle may lock up (e.g., cease to rotate) and thereby begin the slide on the road surface. The amount of force provided by the friction brakes and the traction motor may be less than the threshold at which the wheels lock up (e.g., wheel lock threshold). The force provided by the friction brakes and/or the traction motor may be increased or decreased to keep the braking force applied to the wheel just below the wheel lock threshold to provide a high level of braking force without locking up the wheel.

Further, a central brake controller may be used to coordinate the application of friction brakes and/or traction motor braking to the wheels of the electric vehicle to keep the wheels from locking up and further from keeping the electric vehicle from rotating (e.g., spinning) as a result of a torsion force.

### BRIEF DESCRIPTION OF THE DRAWING

Embodiments of the present invention will be described with reference to the figures of the drawing. The figures present non-limiting example embodiments of the present disclosure. Elements that have the same reference number are either identical or similar in purpose and function, unless otherwise indicated in the written description.

FIG. 1 is a diagram of an example embodiment of a braking system according to various aspects of the present disclosure.

FIG. 2 the diagram of a first embodiment of a drive and traction control system.

FIG. 3 is a diagram a second embodiment of a drive and traction control system.

FIG. 4 is a diagram of the wheel traveling over the surface of a road, the coefficient of friction of the various portions of the surface of the road, the wheel lock threshold and the applied brake force.

FIGS. 5-8 are diagrams of the wheel lock threshold and the applied brake force for a single wheel under various circumstances.

FIG. 9 is a diagram of an electric vehicle traveling down a road with the wheel lock threshold and applied brake force for each wheel.

FIGS. 10-11 are diagrams of an embodiment of a washer fluid system.

FIG. 12 is a diagram of the embodiment of the washer fluid system from an exterior of an electric vehicle.

FIG. 13 is a partial cutaway of the electric vehicle to show the portion of the embodiment of the washer fluid system positioned inside the body of the electric vehicle.

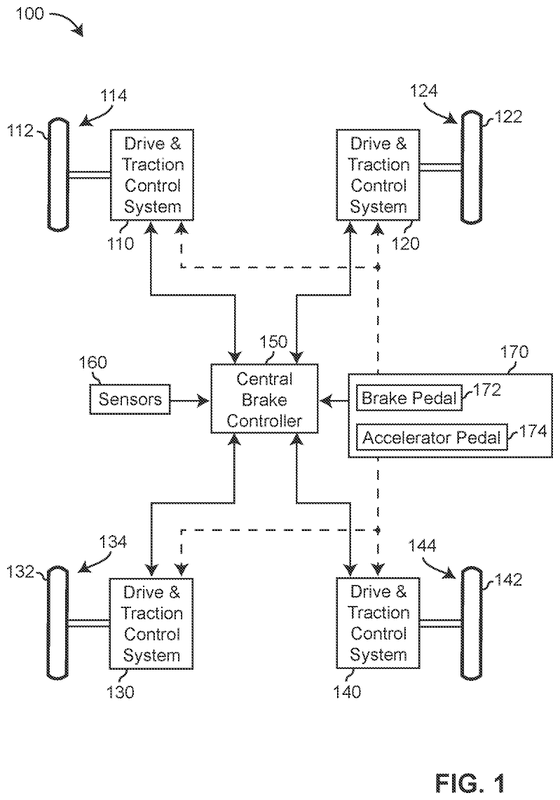

### DETAILED DESCRIPTION

### Overview

An example embodiment of the present disclosure relates to a braking system for an electric vehicle 100. The braking system employs friction brakes (e.g., disc brakes, 210) and traction motor (e.g., 220) braking to slow the rotation of the wheels (e.g., 112, 122, 132, 142). In an example embodiment, each wheel operates independent of all other wheels. In another example embodiment, two or three wheels may be controlled and/or operated together. The example embodiment uses sensors (e.g., 230) to detect the wheel lock threshold, which is the threshold applied braking force at which one or more wheel of the electric vehicle 100 locks up (e.g., stops rotating) and begins to slide on the road in response to the braking force applied.

In an example embodiment, each wheel (e.g., 112, 122, 132, 142) includes a respective drive and traction control system (e.g., 110, 120, 130, 140). The drive and traction control system includes sensors (e.g., 230) that detect when the wheel associated with the drive and traction control system is going to lock up and/or start slipping on the road surface. The sensors may detect lock up and/or slipping using any technique. The drive and traction control system receives data (e.g., information) from other systems in the electric vehicle 100 to aid in detecting lock up or wheel slip. The data may include the speed of the vehicle, the speed of the wheel, the RPMs of the wheel, acceleration and/or inertial data provided by gyroscopes (e.g., 3D gyroscopes).

The electric vehicle 100 may further include a central brake controller 150. The central brake controller 150 may coordinate the braking force applied to each wheel (e.g., 112, 122, 132, 142) by its respective drive and traction control system (e.g., 110, 120, 130, 140). The central brake controller may include sensors that are independent of the sensors for the respective drive and traction control systems. The sensors of the central brake controller 150 may include any type of sensor including linear accelerators and/or gyroscopes. In an example embodiment, the sensors are adapted to detect a torsion force on the electric vehicle. The central brake controller 150 may further receive data from the sensors of the respective drive and traction control systems. The central control of braking may control the various drive and traction control systems to reduce torsion forces acting on the electric vehicle 100 that may result in spinning the electric vehicle 100.

In an example embodiment, the drive and traction control systems (e.g., 110, 120, 130, 140) operate independently of each other and the central brake controller 150 to apply a braking force to the wheels to keep the wheels from locking up. In another example embodiment, the central brake controller 150 controls the drive and traction control systems (e.g., 110, 120, 130, 140) to reduce a torsion force on the electric vehicle 100. In the event that one or more of the drive and traction control systems (e.g., 110, 120, 130, 140) fail, the central brake controller 150 may perform the functions of the failed drive and traction control systems.

### User Input

In an example embodiment, a driver (e.g., user) of an electric vehicle 100 provides information to the electric vehicle 100 as to acceleration, deceleration, speed and direction of travel using an accelerator pedal 174, a brake pedal 172 and a steering wheel (not shown) respectively.

When the brake pedal 172 is pressed by the driver, the drive and traction control systems 110, 120, 130 and 140 are instructed to apply a braking force to the wheels 112, 122, 132 and 142 respectively. When the brake pedal 172 is released by the driver, the drive and traction control systems 110, 120, 130 and 140 are instructed to release the braking force from the wheels 112, 122, 132 and 142 respectively. The braking force (e.g., 212, 222) provided by the drive and traction control systems 110, 120, 130 and 140 may be provided by the friction brake 210 and/or the traction motor 220 of the respective the drive and traction control systems 110, 120, 130 and 140.

When the accelerator pedal 174 is pressed by the driver, the traction motors 220 of the respective drive and traction control systems 110, 120, 130 and 140 is instructed (e.g., controlled) to provide a force to rotate the wheels 112, 122, 132 and 142 respectively. When the accelerator pedal 174 is released by the driver, the traction motors 220 of the respective drive and traction control systems 110, 120, 130 and 140 are instructed to not provide a force to rotate the wheels 112, 122, 132 and 142 respectively. It is conceivable that the driver may press the brake pedal 172 and the accelerator pedal 174 at the same time. In such a situation, the drive and traction control systems 110, 120, 130 and 140 may determine whether or not to apply a braking force and/or the strength (e.g., amount) of the braking force.

Information as to whether the driver has pressed the brake pedal 172 and/or the accelerator pedal 174 may be provided to the drive and traction control systems 110, 120, 130 and 140 and/or the central brake controller 150 in any manner. In an example embodiment, information as to the current state of the brake pedal 172 and/or the accelerator pedal 174 may be transmitted to the drive and traction control systems 110, 120, 130 and 140 and/or the central brake controller 150 as digital data.

### Drive and Traction Control System—First Embodiment

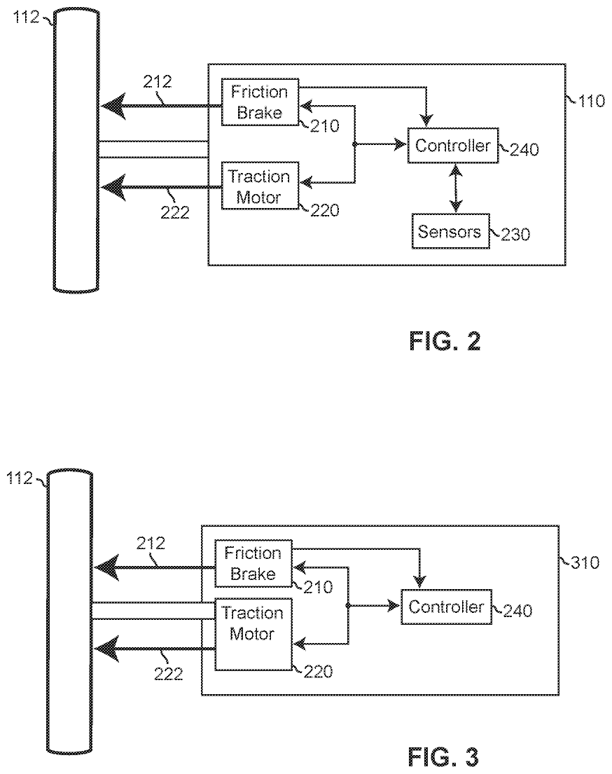

The drive and traction control system 110, shown in FIG. 2, is provided as an example of a first embodiment of the drive and traction control system. The first embodiment of the drive and traction control system (e.g., 110, 120, 130, 140) includes a friction brake 210, a traction motor 220, sensors 230 and a controller 240. Each drive and traction control system is associated with and controls a wheel (e.g., 112, 122, 132, 142) respectively.

The friction brake 210 is configured (e.g., adapted) to provide a friction brake force 212 to the wheel to slow the rotations of the wheel. The traction motor 220 is configured to provide a traction motor brake force 222 to the wheel. The traction motor 220 may provide the traction motor brake force 222 to the wheel directly or via any type of transmission. The traction motor brake force 222 from the traction motor 220 may act to start and/or continue rotation the wheel. The traction motor brake force 222 from the traction motor 220 may cause the rotation of the wheel to accelerate (e.g., increase). The traction motor brake force 222 from the traction motor 220 may cause, in the context of braking, the rotation of the wheel to deaccelerate (e.g., decrease). The traction motor brake force 222 from the traction motor 220 may cause the rotation of the wheel to deaccelerate by applying the traction motor brake force 222 in the opposite direction of the present direction of rotation of the wheel. For example, suppose that the wheel 112 is rotating in the clockwise direction (e.g., forward movement for the electric vehicle 100). The traction motor 220 may cause the rotation of the wheel 112 to decrease by applying the traction motor brake force 222 in the counterclockwise direction.

The friction brake 210 may include any type of a system and/or device that uses friction to provide the friction brake force 212. For example, the friction brake 210 includes any type of brake (e.g., disc, drum) that presses (e.g., forces) friction material (e.g., pad, drum) into contact with a structure of the wheel (e.g., rotor) to slow or stop rotation of the wheel 112. The friction brake 210 may operate independent of the traction motor 220. The friction brake force 212 is provided (e.g., operated) independent of the traction motor brake force 222.

As discussed above, the traction motor 220 is configured to provide a force to rotate the wheel 112. The traction motor 220 may provide a force that causes the electric vehicle 100 to rotate in a clockwise (e.g., forward) or a counterclockwise (e.g., rearward, backward) direction from the perspective of an inside 114, 124, 134, 144 of the wheel 112, 122, 132, 142 respectively. If the wheel 112 is not presently rotating, a force provided by the traction motor 220 causes the wheel 112 to begin rotating. If the wheel 112 is presently rotating, a force provided in the present direction of rotation causes the wheel 112 to continue rotating or to accelerate in rotation.

The traction motor 220 is further configured to provide a traction motor brake force. If the wheel 112 is presently rotating, a force provided in the direction opposite the present direction of rotation (e.g., reverse load) causes the wheel 112 to slow and/or stop its rotation. The term traction motor braking force refers to the traction motor brake force 222 that slows the rotation of the wheel. In an example embodiment, the traction motor brake force 222 refers to a force provided by the traction motor 220 in the direction opposite to the current direction of rotation of the wheel 112. Applying the traction motor brake force 222 results in slowing or stopping the rotation of the wheel 112. The traction motor 220 may also slow or stop the rotation of the wheel 112 by switching the mode of operation of the traction motor 220 so that it functions as a generator. The traction motor 220 operating in the regenerative mode slows and/or stops the rotation of the wheel 112.

As discussed above, the friction brake force and/or the traction motor brake force may be used to slow or stop the rotation of a wheel. Stopping the rotation of the wheel, as used herein, is different from locking up a wheel. The term stopping the rotation of the wheel refers to applying the applied brake force to the wheel until the wheel stops rotating and the vehicle to which the wheel is attached comes to a halt. The term locking up a wheel refers to the situation in which the applied braking force causes the wheel to cease rotating while the vehicle to which the wheels attached continues moving. When a wheel locks up, the momentum of the vehicle causes the wheel to slide or skid across the surface on which the wheel travels. Stopping the rotation of a wheel refers to slowing the rotation of a tire, and therefore the velocity of the vehicle, until the tire ceases to rotate and the vehicle comes to arrest.

The sensors 230 include sensors for detecting the speed of rotation of the wheel 112 (e.g., revolutions per minute, RPM, angular speed), the position of the wheel 112, and the linear speed of the wheel 112. The sensors 230 may further include sensors for detecting linear acceleration in any direction. The sensors 230 may further include sensors for detecting angular velocity of the wheel. The sensors 230 may detect whether the wheel 112 is locked up (e.g., not rotating). The sensors 230 may detect whether the wheel 112 is locked up as a result of the braking force applied to the wheel 112. The sensors 230 may detect whether the wheel 112 is slipping with respect to the road surface. The sensors may detect a magnitude (e.g., amount, strength) of the friction brake force 212 and/or a magnitude of the traction motor brake force 222. The sensors may detect an effect (e.g., result) of the friction brake force 212 and/or the traction motor brake force 222 on the wheel 112. For example, the sensors may detect when the effectiveness of the friction brake 210 decreases (e.g., fades). The sensors 230 may detect a temperature, such as the temperature of the wheel 112, the temperature of the traction motor 220, the temperature of the friction brake 210 and/or the atmospheric temperature. The sensors 230 may detect a change in any temperature that it detects. For example, the sensors 230 may detect an increase in the temperature of the wheel 112 caused by applying the friction brake force 212.

The sensors 230 may provide data in accordance with sensing (e.g., detecting) to the controller 240. The sensors 230 may communicate with the controller 240 in any manner. In an example embodiment, the sensors 230 provide information (e.g., data) that is been sensed to the controller 240 as digital data. The sensors 230 may receive data from the controller 240. The sensors 230 may receive data to initialize and/or control the sensors 230. The controller 240 may synchronize the operation of the sensors 230.

The controller 240 includes any type of electric, electronic and/or electromechanical device for controlling (e.g., providing data and/or control signals to) the friction brake 210, receiving data from the friction brake 210, controlling the traction motor 220, receiving data from the traction motor 220, receiving data from the sensors 230, controlling the sensors 230 and/or performing calculations and/or manipulating data. The controller 240 may include electromechanical devices (e.g., relays, solenoids), a processing circuit (e.g., microprocessor, microcontroller, signal processor), and memory (e.g., semiconductor, magnetic), analog-to-digital converters, digital-to-analog converters, sampling circuits and/or buses (e.g., address/data, serial) for communication.

The controller 240 may use information from the sensors 230 to calculate and/or estimate the speed of the electric vehicle 100. The controller 240 may compare the calculated and or estimated speed of the electrical vehicle 100 to the linear speed of the wheel 112 to determine the slip of the wheel 112. Detecting and calculating the spin of a tire may be used to detect and/or calculate the wheel lock threshold. The controller 240 may receive data regarding the speed of the vehicle. The controller 240 may compare the speed of the electric vehicle 100 to the linear speed of the wheel 112 to determine the slip of the wheel 112. The controller 240 may use data from the sensors 230 to control the friction brake 210 and the traction motor 220. The controller 240 may receive data and/or control signals from the central brake controller 150 and/or user input 170 provided by a driver via the brake pedal 172 and the accelerator pedal 174. The data from the central brake controller 150 and/or the user input 170 may be used to control the friction brake 210 and the traction motor 220.

The controller 240 may control the rotation, position, rotational speed, rotational acceleration, rotational deceleration and the linear speed of the wheel 112 via the friction brake 210 and the traction motor 220. The controller 240 may perform any type of calculation. The controller 240 may use any data to perform a calculation. The controller 240 may perform any action and/or control another device (e.g., friction brake 210, traction motor 220, sensors 230) using any data and/or results of any calculation.

The controller 240 may store data received from the sensors 230, the central brake controller 150 and/or the user input 170. The controller 240 may keep a historical record of data received and/or calculated over a period of time. The controller 240 may receive data in any manner and via any type of communication link whether wired or wireless. The controller 240 may provide data to the central brake controller 150 and/or the user input 170 in any manner and via any type of communication link whether wired and/or wireless.

### Drive and Traction Control System—Second Embodiment

A second embodiment of the drive and traction control system (e.g., 110, 120, 130, 140) includes the friction brake 210, the traction motor 220 and the controller 240. The second embodiment of the drive and traction control system does not include the sensors 230. However, since in this embodiment the traction motor 220 is a direct drive motor the (e.g., connects directly to wheel 112), the traction motor 220 may provide information regarding wheel speed, wheel position, wheel acceleration, wheel deceleration and/or the linear speed of the wheel 112 to the controller 240. Accordingly, the second embodiment of the drive and traction control system (e.g., 110, 120, 130, 140) may perform many if not all of the functions of the first embodiment.

### Central Brake Controller

In an example embodiment, the electric vehicle 100 further includes the central brake controller 150 and sensors 160. The central brake controller 150 receives data from each drive and traction control system 110, 120, 130 and 140. The central brake controller 150 provides data to each drive and traction control system 110, 120, 130 and 140. In an example embodiment, some or all of the drive and traction control systems 110, 120, 130 and 140 provide data regarding the wheel lock threshold and/or the applied braking force as determined by the drive and traction control system to the central brake controller 150. The central brake controller 150 may provide instructions (e.g., commands) to one or more of the drive and traction control systems 110, 120, 130 or 140 to control the operation of the drive and traction control system in whole or in part.

The sensors 160 are separate and distinct from the sensors 230 of the respective drive and traction control systems 110, 120, 130 and 140. The sensors 160 may duplicate some of the measurements detected by the sensors 230. The sensors 160 may detect physical phenomena (e.g., speed of the electric vehicle 100, spin of the electric vehicle 100) that may be difficult for the sensors 230 to detect. In an example embodiment, a sensors 160 are adapted to detect a torsion force on the electric vehicle. A torsion force may cause the electric vehicle to spin (e.g., rotate). The sensors 160 provide a data regarding the physical phenomena detected to the central brake controller 150. The central brake controller 150 may further receive data from the sensors 230.

As with the controller 240, the central brake controller 150 may include any type of electric, electronic and/or electromechanical devices for controlling, receiving data from and providing data to the drive and traction control systems 110, 120, 130 and/or 140. The central brake controller 150 may perform calculations, use data to perform calculations, store data and/or store results of calculations. The central brake controller 150 may include a memory for storing and retrieving data.

The central brake controller 150 may control the drive and traction control systems 110, 120, 130 and 140, and thereby the wheels 112, 122, 132 and 142 respectively, independently of each other. The central brake controller 150 may control the drive and traction control systems 110, 120, 130 and 140 serially and/or in parallel, at the same time and/or at different times. The central brake controller 150 may control each the drive and traction control systems 110, 120, 130 and 140 independently to prevent lock up of one or more wheels 112, 122, 132 and/or 142 and/or to cause lockup of one or more wheels. In an example embodiment, the central brake controller 150 receives data from and provides data to at least two drive and traction control systems.

The central brake controller 150 may control each the drive and traction control systems 110, 120, 130 and 140 independently to reduce a likelihood that a torsion (e.g., spin) force applied on the electric vehicle 100 that may cause the electric vehicle 100 to spin. For example, in an example embodiment, responsive to the sensors 160 detecting a torsion force, the central brake controller 150 analyzes data from some or all of the drive and traction control systems 110, 120, 130 and 140 to determine a possible cause (e.g. source) of the torsion force. The data analyzed by the central brake controller 150 includes the wheel lock threshold as determined by the drive and traction control systems. The data analyzed by the central brake controller 150 may further include the applied braking force applied by each drive and traction control system on its respective wheel 112, 122, 132 and 142. Responsive to analyzing the data from the one or more drive and traction control systems, the central brake controller 150 controls (e.g., coordinates) the operation of some or all of the drive and traction control systems 110, 120, 130 and 140 to reduce the torsion force.

The action taken by the central brake controller 150 depends on the circumstances and operation of each drive and traction control systems 110, 120, 130 and 140 and each wheel 112, 122, 132 and 142. For example, the wheels on one side of the vehicle, for example wheels 112 and 132, may be locked up thereby causing a torsion force on the electric vehicle 100 that causes the electric vehicle 100 to spin counterclockwise as viewed above the electric vehicle 100. The central brake controller 150 may reduce the applied brake force on the wheel 112 and or the wheel 132 to reduce the torsion force or it may increase the applied brake force on the wheel 122 and the wheel 142 to reduce the torsion force. In another scenario, the central brake controller 150 may release the applied braking force on the wheels 112 and 132, engage the traction motor attached to wheels 112 and 132 to cause them to rotate to move the electric vehicle 100 in a forward direction, and increase the applied braking force on the wheels 122 and 142. In another scenario, the central brake controller 150 may increase the applied brake force on a wheel to the point of causing the wheel to lock up; however, preferably the central brake controller 150 increases and/or decreases the applied braking force to the various wheels to avoid lockup while reducing the torsion force. In an example embodiment, the central brake controller 150 controls the operation of one or more of the drive and traction control systems 110, 120, 130 and 140 two reduce the torsion force.

In another example, as the electric vehicle 100 travels, the road surface 452 may change under each wheel 112, 122, 132 and 142 rapidly and disparately. The surface of the road under one wheel may change so that the wheel lock threshold increases or decreases significantly and rapidly. A significant decrease in the wheel lock threshold may result in the applied braking force causing the wheel to lock up. A significant increase in the wheel lock threshold may result in less slowing of the tire for that drive and traction control system. The central brake controller 150 may detect the changes between the operation of the different drive and traction control systems and may provide data (e.g., instructions) to one or more of the drive and traction control systems 110, 120, 130 and 140 to increase or decrease the respective applied brake force. The central brake controller 150 may instruct a change in the applied brake force with the goal of decreasing the torsion force acting on the electric vehicle 100 and not necessarily to maintain the applied brake force at or below the wheel lock threshold. The central brake controller 150 may further control the forward or reverse rotation of a wheel.

As discussed herein, the drive and traction control systems operate to maintain the applied brake force to be less than or equal to the wheel lock threshold for the wheel associated with drive and traction control systems. As the central brake controller 150 analyzes data (e.g., wheel lock threshold, applied brake force, rotation of the wheel, speed of the rotation of the wheel, linear speed of the wheel) from the drive and traction control systems, it may determine that the applied brake force should be increased to be greater than the wheel lock threshold, at least for a period of time. The central brake controller 150 may determine that the applied brake force should be reduced to be significantly less than the wheel lock threshold, at least for a period of time. The central brake controller 150 may determine that a traction motor should cause its related wheel to rotate forward or backward, at least for a period of time. The central brake controller 150 may provide instructions to one or more of the drive and traction control systems 110, 120, 130 and 140 to cause one or more of the drive and traction control systems to operate in such a manner as to reduce a torsion force on the electric vehicle 100.

In the event that one or more of the drive and traction control systems 110, 120, 130 and 140 fails, the central brake controller 150 may perform the functions of the failed drive and traction control systems. The data detected by the sensors 230 of the failed drive and traction control systems is sent to the central brake controller 150. The central brake controller 150 may perform the calculations and provided control signals as the controller 240 would have provided had the drive and traction control system not failed.

In the event that the central brake controller 150 fails (e.g., ceases to operate, breaks) or ceases to operate properly, the drive and traction control systems 110, 120, 130 and 140 may continue to operate independently to stop lockup of the wheels 112, 122, 132 and/or 142 respectively. Loss of the central brake controller 150 may reduce the ability of the electric vehicle 100 to maintain control the wheels 112, 122, 132 and/or 142 to reduce a torsion force that causes the electric vehicle 100 to spin.

### Wheel Lock Threshold

The wheel lock threshold 420 represents a threshold braking force. The wheel lock threshold 420 is the threshold at which one or more the wheels 112, 122, 132 and/or 142 ceases to rotate in response to an applied brake force on the wheel. If the braking force applied to the wheel is greater than the wheel lock threshold 420, the wheel will lock up and will not rotate. If the braking force applied to the wheel is less than or equal to the wheel lock threshold 420, then the applied brake force will slow, and eventually stop, the rotation of the wheel without locking up the wheel. The wheel lock threshold 420 may change in accordance with the condition of the surface 452 of the road 450 over which the wheels 112, 122, 132 and/or 142 travel. If the applied brake force (e.g., 430, 530, 630, 730, 830, 914, 924, 934, 944) is greater than the wheel lock threshold (e.g., 420, 912, 922, 932, 942) then the wheel stops rotating responsive to the applied brake force. When the wheel stops rotating, responsive to the applied brake force and the surface of the road, the wheel begins to slide on the surface of the road.

When a wheel locks up, the coefficient of friction between the wheel and the road is the kinetic coefficient of friction. When a wheel rolls along the surface of the road, without locking, the coefficient of friction between the wheel and the road is the static coefficient of friction. Generally, the static coefficient of friction is higher than the kinetic coefficient of friction, so the electric vehicle 100 will stop more quickly if the wheels do not lockup.

The central brake controller 150 and/or the drive and traction control systems 110, 120, 130 and 140 may detect when the wheels 112, 122, 132 and/or 142 are locked up or near locking up, accordingly, the central brake controller 150 and/or the drive and traction control systems 110, 120, 130 and 140 may determine the wheel lock threshold. The central brake controller 150 and/or the drive and traction control systems 110, 120, 130 and 140 (e.g., controller 240 thereof) may use any data detected by the sensors 230, the sensors 160 and/or a direct drive traction motor to detect wheel lock and/or determine the wheel lock threshold 420.

### Applied Brake Force

The applied braking force is a combination of the friction brake force and the traction motor brake force. The applied brake force is the force applied upon the wheels 112, 122, 132 and/or 142 to slow or stop the rotation of the wheels 112, 122, 132 and/or 142 respectively. The applied brake force may be the friction brake force 212 provided by the friction brake 210, the traction motor brake force 222 provided by the traction motor 220, or any combination thereof. The friction brake force 212 and/or the traction motor brake force 222 may be determined and set by the controller 240 and/or the central brake controller 150. The controller 240 and/or the central brake controller 150 may control the operation of at least one of the friction brake 210 and the traction motor 220 to provide the applied braking force. The controller 240 and/or the central brake controller 150 may control the operation of at least one of the friction brake 210 and the traction motor 220 to provide, stop providing, increase or decrease the applied braking force. The controller 240 and/or the central brake controller 150 may control the operation of at least one of the friction brake 210 and the traction motor 220 to maintain the applied brake force (e.g., 430) at or below the wheel lock threshold (e.g., 420). Maintaining the applied brake force at or below the wheel lock threshold causes the rotation of the wheel to decrease rather than locking up.

In an example embodiment, the controller 240 and/or the central brake controller 150 determines the wheel lock threshold (e.g., 420, 912, 924, 932, 942) and controls the operation of the friction brake 210 and/or the traction motor 220 to set the applied brake force to provide a force that is less than, but preferably close to, the wheel lock threshold. The controller 240 and/or the central brake controller 150 may determine the combination of the friction brake force 212 and the traction motor brake force 222 to provide the applied brake force (e.g., 430).

In an example embodiment, the friction brake force 212 is added to the traction motor brake force 222, or vice versa, to provide the applied brake force. The controller 240 and/or the central brake controller 150 may determine the amount (e.g., magnitude, ratio) of the friction brake force 212 and the traction motor brake force 222 that are combined to be the applied brake force. The controller 240 and/or the central brake controller 150 may change the amount of the friction brake force 212 and the traction motor brake force 222 at any time and in any direction (e.g., decrease, increase). The controller 240 and/or the central brake controller 150 may change the amount of the friction brake force 212 and the amount of the traction motor brake force 222 while maintaining the applied brake force at or below the wheel lock threshold 420.

The controller 240 and/or the central brake controller 150 may control the friction brake force 212 and the traction motor brake force 222 in any manner to provide the applied brake force. For example, the controller 240 and/or the central brake controller 150 may keep the traction motor brake force 222 at a constant value (e.g., amount) and increase or decrease the friction brake force 212 to provide an applied brake force that is preferably just below (e.g., less than) the wheel lock threshold. The controller 240 and/or the central brake controller 150 may keep the friction brake force 212 at a constant value and increase or decrease the traction motor brake for 222 to keep the applied brake force at or below the wheel lock threshold.

The controller 240 and/or the central brake controller 150 may determine the amount of the friction brake force 212 and the traction motor brake force 222 that make up the applied brake force. The ratio between the friction brake force 212 and the traction motor brake force 222 may be changed at any time and for any reason. For example, the amount of the traction motor brake force 222 provided may be increased as a result of a reduction in performance of the friction brake 210 and the amount of the friction brake force 212 that the friction brake 210 is capable of providing. Such a situation may occur when the friction brake begins to fade due to heat. The controller 240 and/or the central brake controller 150 may combine an amount of the friction brake force 212 with an amount of the traction motor brake force 222 to provide a constant applied brake force.

### In Operation—Individual Wheel

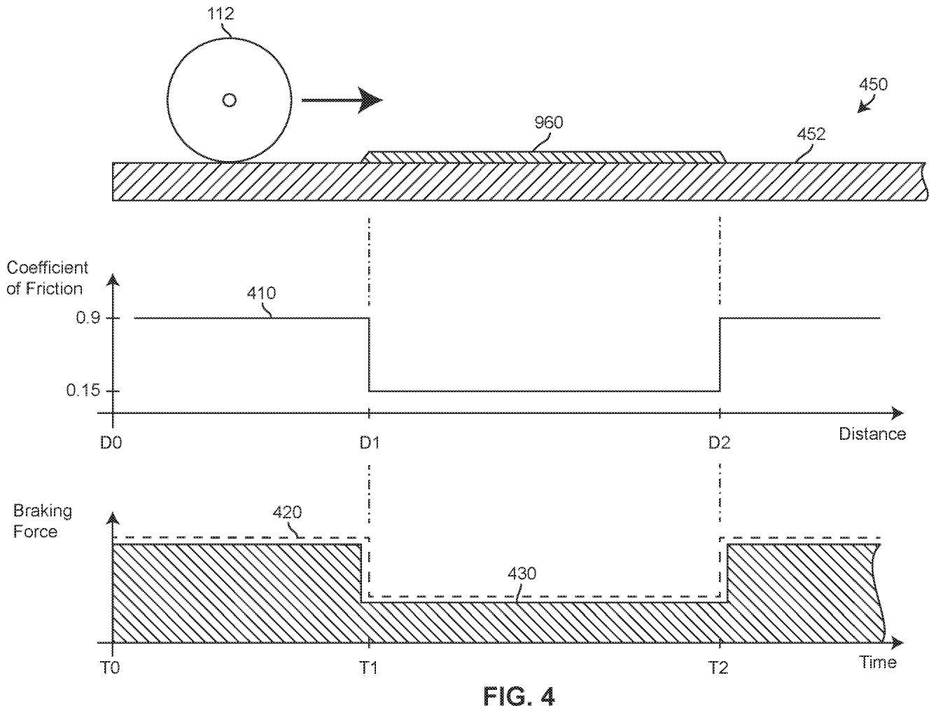

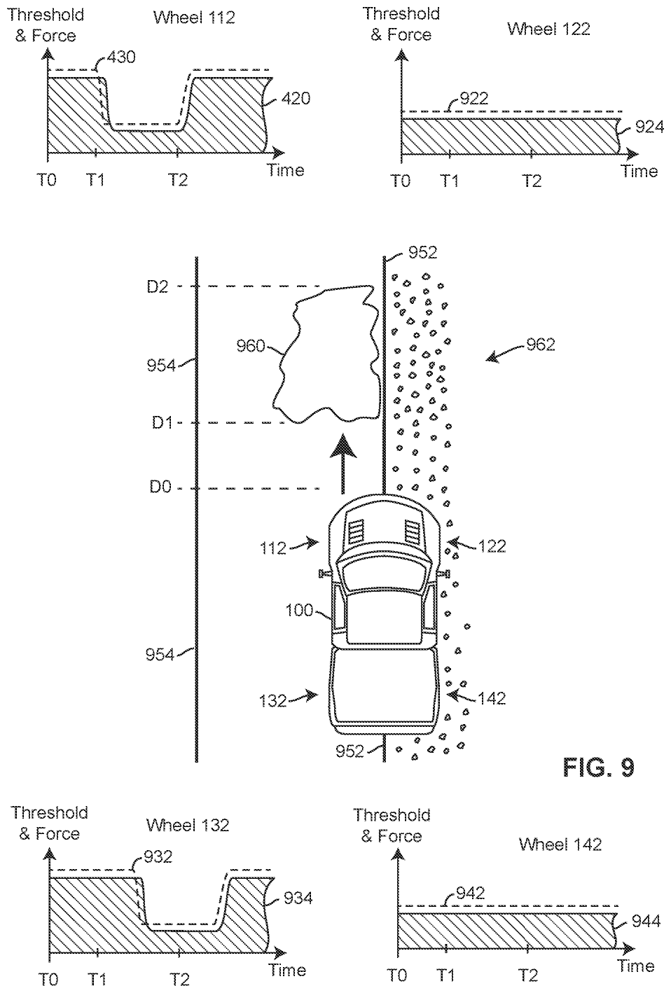

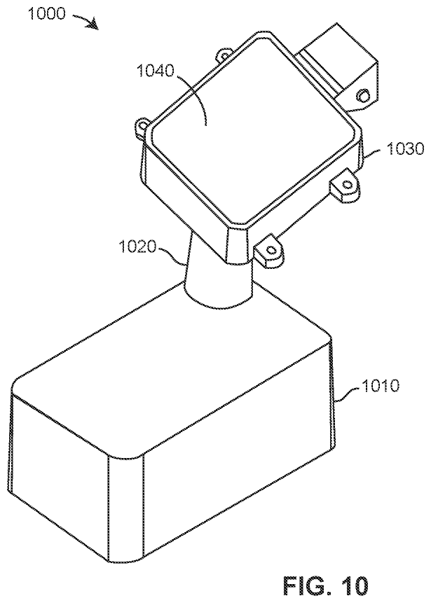

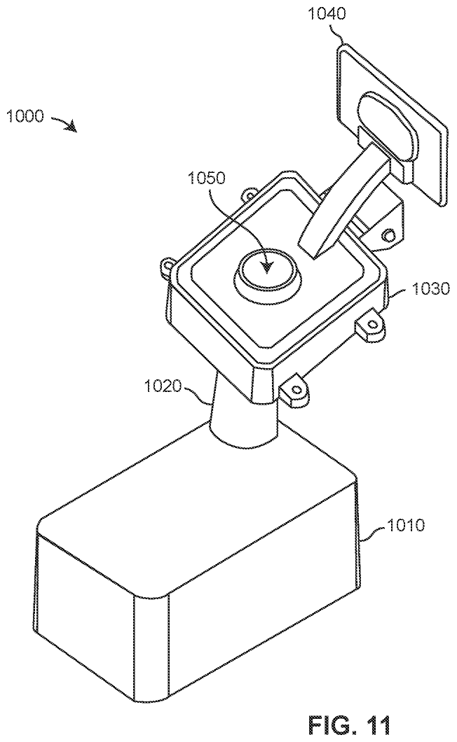

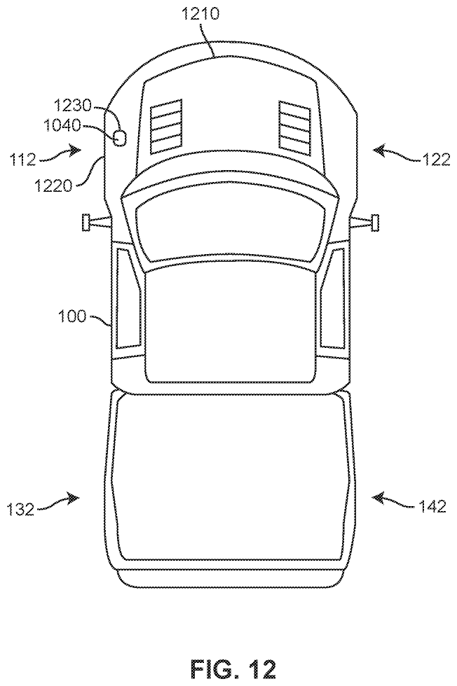

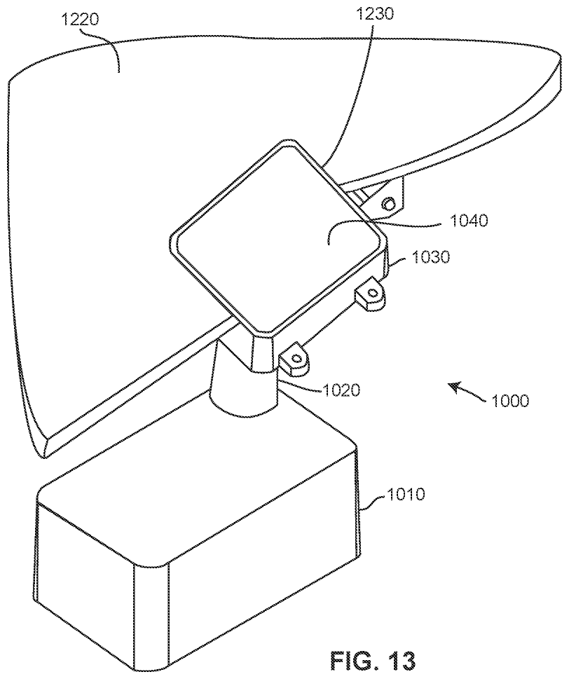

Controlling and providing the friction brake force for a single wheel (e.g., 112) is illustrated in FIGS. 4-8. The times (e.g., T0, T1, T2) are common to (e.g., the same in) the diagrams of FIGS. 4-9. Referring to FIG. 4, the wheel 112 travels rightward from the left side of the page to the right side of the page on the road 450. The distance traveled along the road starts at the point D0 and goes past the point D2. The points D0, D1 and D2 are also shown in FIG. 9, but in FIG. 9, the vehicle travels upward on the page as opposed to rightward. The times T0, T1 and T2 as shown in FIGS. 4-9 correspond to the time at which the wheel 112 is positioned at points D0, D1 and D2 respectively.

Between the points D0 and D1 and from the point D2 onward, the surface 452 of the road 450 is clean and dry thereby providing the maximum traction, as represented by the high static coefficient of a friction of 0.9. Between the points D1 and D2, the surface 452 is covered by some type of a slick substance (e.g., ice, oil). Accordingly, the static coefficient of friction between point D1 and D2 decreases significantly to 0.15. The kinetic coefficients of friction between point D0 and D1 and points D1 and D2 are less than their respective static coefficient of friction. For example, in this example, the static coefficient of friction between the points D0 and D1 is 0.7 and 0.1 between the point D1 and D2. So, while the wheel 112 is traveling along the road 450, when it reaches point D1, the static coefficient of friction between the wheel 112 and the surface 452 of the road 450 changes dramatically. If the wheel 112 locks up, the coefficient of friction between the wheel 112 and the surface 452 reduces even further to the kinetic coefficient of friction.

The coefficient of friction 410 along the road 450 between the point D0 and D1 and from the point D2 onward is shown as 0.9. The coefficient of friction 410 drops rapidly and significantly from 0.9 to 0.15 at the point D1 and increases rapidly and significantly at the point D2 back to 0.9. The wheel lock threshold 420 is affected by the coefficient of friction of the surface 452 of the road 450. For example, the wheel lock threshold 420 increases or decreases in accordance with a coefficient of friction of a surface of a road in contact with the wheel. If the coefficient of friction 410 decreases, the wheel lock threshold 420 decreases which means that the applied brake force 430 needs to decrease to remain less than or equal to the wheel lock threshold 420 so as to not lock up the wheel. If the coefficient of friction 410 increases, the wheel lock threshold 420 increases which means that the applied brake force 430 may increase to apply a greater brake force to the wheel without locking up the wheel. In an example embodiment, the wheel lock threshold is proportional to the coefficient of friction of the surface of the road in contact with the wheel. So, as a coefficient of friction of the surface of the road in contact with the wheel changes, the wheel lock threshold also changes.

Returning to the example of FIG. 4, while the wheel 112 is traveling between the points D0 and the point D1 and from the point D2 onward, the wheel lock threshold 420 is high because the surface 452 of the road 450 provides a reasonably high coefficient of friction. However, between the points D1 and D2, the wheel lock threshold 420 decreases rapidly and significantly because the wheel 112 will lock up and not rotate if the applied brake force 430 is not decreased.

In FIG. 4, braking begins at point D0 at time T0. The wheel 112 reaches the point D1 at time T1 and the point D2 at the time T2. In FIG. 4, the applied brake force 430 provided to the wheel 112 is maintained at just below the wheel lock threshold 420. So, when the wheel reaches the point D1 at time T1, where the surface 452 has a low coefficient of friction, the applied brake force 430 is reduced rapidly and significantly to maintain the applied brake force below the wheel lock threshold 420. When the wheel 112 reaches the point D2 at time T2, where the coefficient of friction of the surface 452 of the road 450 increases, the applied brake force 430 also increases to remain just below the wheel lock threshold 420.

The sensors 230 and 160 continuously detect the operation and movement of the electric vehicle 100 to provide the controller 240 and/or the central brake controller 150 with data for determining the wheel lock threshold 420. In FIG. 4, because the applied brake force 430 remains at or below the wheel lock threshold 420, the wheel 112 does not stop rotating or slide along the surface 452 of the road 450. Because the applied brake force 430 is maintained to be at or just slightly less than the wheel lock threshold 420, the applied brake force 430 represents the maximum braking force that may be applied to the wheel 112 without causing the wheel 112 to lock up and slide on the surface 452 of the road 450.

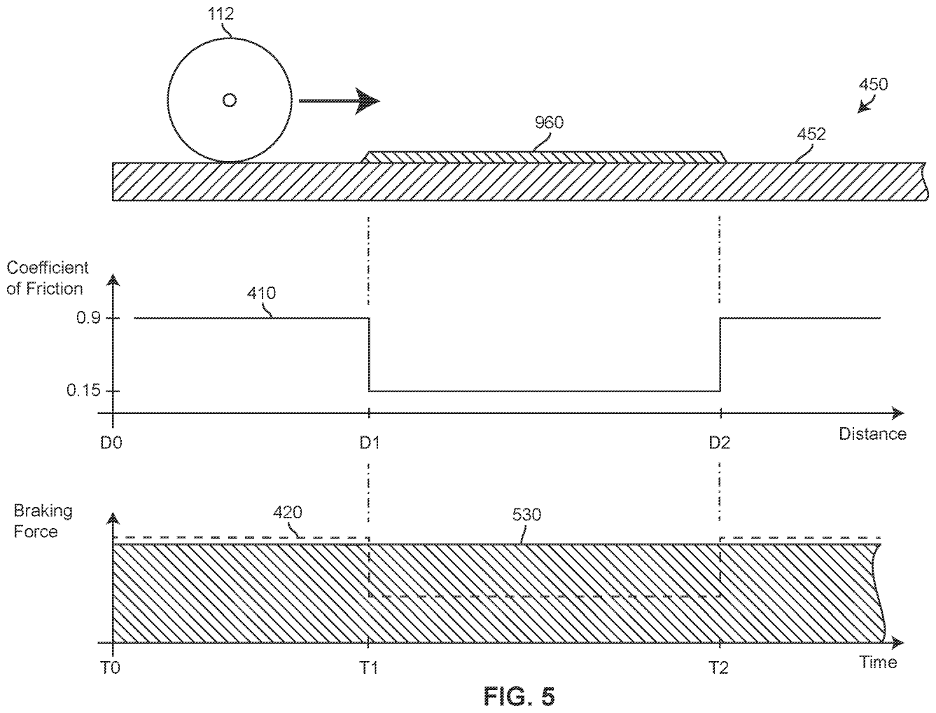

The applied brake force 530 applied in FIG. 5 is constant between the times T1 and T2. So, when the wheel lock threshold 420 drops between the times T1 and T2 due to the decreased coefficient of friction on the road 450, the applied brake force 530 is too high for the road conditions and the wheel 112 locks up and slides across the surface 452 of the road 450. The wheel 112 locks up and begins to slide each time the applied brake force 430 is greater than the wheel lock threshold 420. The applied brake force shown in FIG. 5 is typical of a braking system that does not include anti-lock braking.

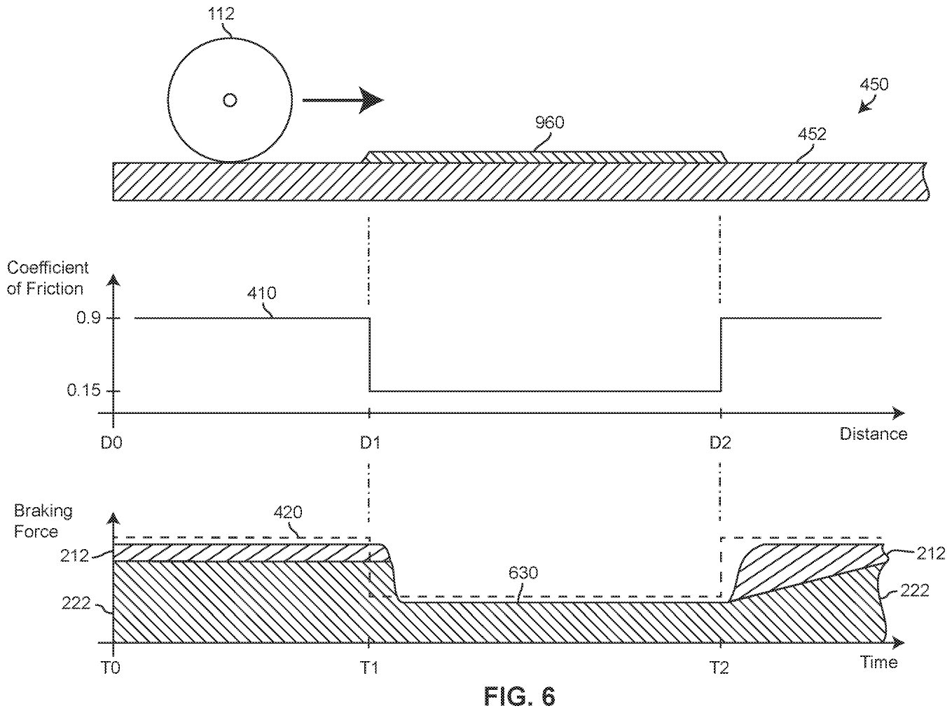

The applied brake force 630, as shown in FIG. 6, is the sum of the friction brake force 212 and the traction motor brake force 222. The sum of the friction brake force 212 and the traction motor brake force 222 between the times T0 and T1 is shown to be just less than the wheel lock threshold 420, which means that the maximum amount of braking force is being applied to the wheel 112 without making the wheel 112 lock up.

At the time T1, in FIG. 6, the wheel 112 contacts the slick 960 on the surface 452 of the road 450. The coefficient of friction between the wheel 112 and the surface 452 drops rapidly as the wheel 112 passes from the clean dry surface to the slick 960. Because the coefficient of friction drops, the wheel lock threshold 420 also drops. As a result, the drive and traction control system 110 and/or the central brake controller 150 reduces the friction brake force 212 to zero and reduces the traction motor brake force 222 to be below the wheel lock threshold 420 to stop the wheel 112 from locking and sliding. In FIG. 6, there is a delay between the decrease in the wheel lock threshold 420 and the applied brake force 630 at the time T1, so the wheel 112 may lock up and slide at least for a short period of time or distance. At time T2 in FIG. 6, the wheel 112 gets past the slick 960, so the coefficient of friction increases, so the wheel lock threshold 420 may also increase. The drive and traction control system 110 and/or the central brake controller 150 responds to the increase in the wheel lock threshold 420 by increasing the traction motor brake force 222 a bit and the friction brake force 212 significantly so that the applied brake force 630 is just below the wheel lock threshold 420.

Referring to FIG. 6, any amount of the friction brake force 212 may be summed with the traction motor brake force 222 to provide the applied brake force 630. Between the time T0 and the time T1, the traction motor brake force 222 provides the majority of the braking force for the applied brake force 630. The amount of the friction brake force 212 may be swapped with the amount of the traction motor brake force 222, so that the friction brake force 212 provides the majority of the braking force for the applied brake force 630.

In another example embodiment, one of the friction brake force and the traction motor brake force provides a base amount while the other provides a remainder amount of the applied brake force. For example, the controller 240 controls the operation of the traction motor to provide the traction motor brake force at a base amount, between 10% and 50%, of the applied brake force 630. The controller 240 further controls the operation of the friction brake to provide the remainder amount, between 90% and 50% respectively, of the applied brake force 630. In an example embodiment, the base amount is constant while the remainder amount varies. For example, the remainder amount is equal to the wheel lock threshold minus the base amount, so as the wheel lock threshold varies, the remainder amount varies to keep the applied brake force 630 at or just below the wheel lock threshold. In another example embodiment, the controller 240 controls the operation of the friction brake 210 and the traction motor 220 to provide the base amount and the remainder amount respectively.

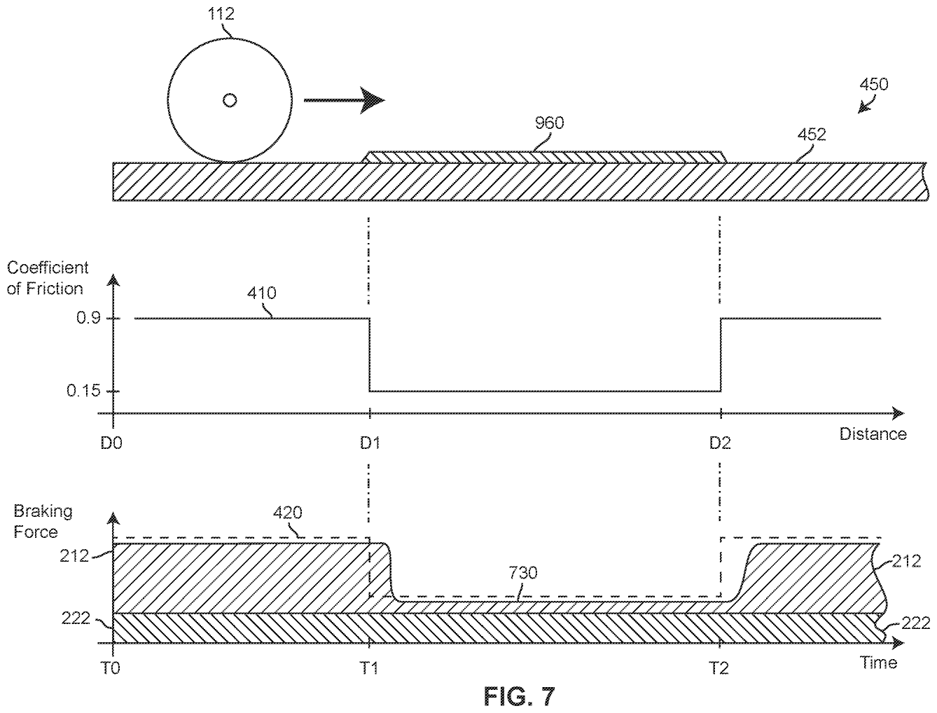

The applied braking for 730 of FIG. 7 is also shown as the combination (e.g., sum) of the friction brake force 212 and the traction motor brake force 222. However, in this example the traction motor brake force 222 is held at a constant amount (e.g., level, value, magnitude) during the entire time of braking from T0 to beyond time T2. The friction brake force 212 provides the remainder of what is needed for the applied brake force 730. Further, the friction brake force 212 is adjusted to compensate for changes in the wheel lock threshold 420 between the times T1 and T2. The drive and traction control system 110 and/or the central brake controller 150 attempt to keep the applied brake force 730 at or below the wheel lock threshold 420. The diagram of FIG. 7 shows a slight delay between the reduction in the coefficient of friction and the wheel lock threshold 420 at the time T1 and the reduction of the friction brake force 212, so the wheel 112 may slip slightly or for a short period of time around the time T1. There is also a slight delay between the increase in the coefficient of friction and the wheel lock threshold 420 at the time T2, and the increase in the friction brake force 212 so that the applied braking for 730 tracks the change in the wheel lock threshold 420.

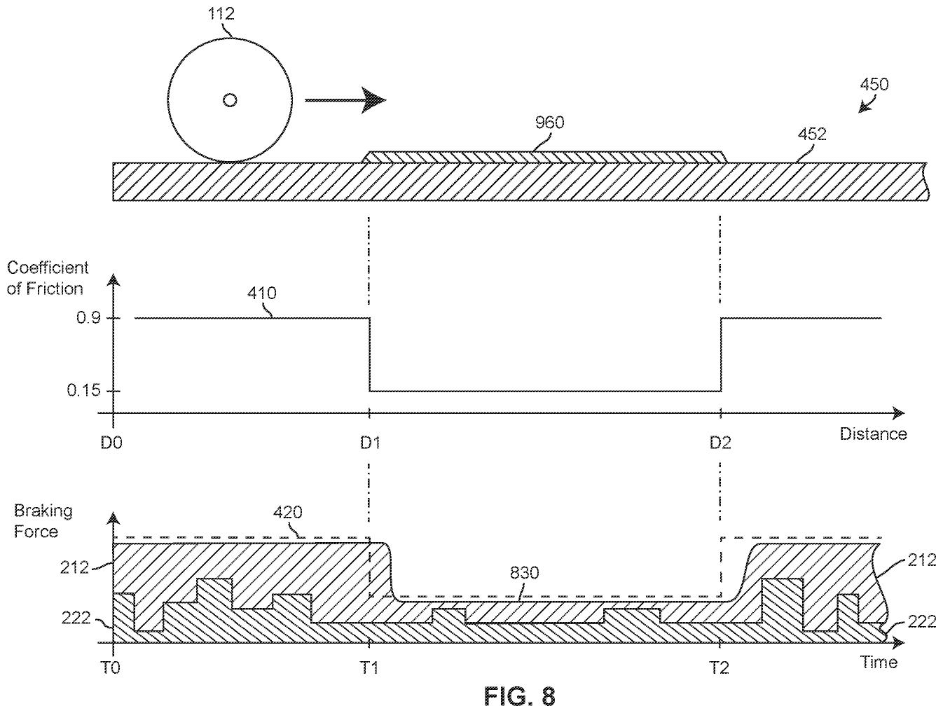

As discussed above, the friction brake force 212 and the traction motor brake force 222 may be altered (e.g., increased, decreased) at any time and for any reason. The diagram of FIG. 8 shows the alteration of the friction brake force 212 and the traction motor brake force 222 throughout the stopping period of the time T0 and beyond the time T2. As one braking force is decreased, the other braking force may increase to maintain the appropriate amount of applied brake force 830. Again, a delay is shown between changes in the applied brake force 830 and changes in the wheel lock threshold 420. The wheel 112 may lock up and slide, at least for a short period of time, each time the applied brake force 830 is greater than the wheel lock threshold 420. In reality, the drive and traction control system 110 and/or the central brake controller 150 respond very quickly (e.g., milliseconds) to detecting a change in the coefficient of friction of the road surface or any slip in the wheel 112. The delay in responding to a change in the wheel lock threshold 420 will likely not be noticeable to the driver.

In an example embodiment, the wheel lock threshold 420 is determined by increasing the applied brake force until the wheel begins to slip, then decreasing the applied brake force until the slip ceases. In another example embodiment, the wheel lock threshold 420 is determined by comparing the linear speed of the wheel to the speed of the vehicle. Each time the linear speed of the wheel is a threshold amount (e.g., 0.1%-5%) greater than or less than the speed of the vehicle, the wheel is slipping.

In an example embodiment, the linear speed of the wheel is determined as follows. Suppose that the wheels of the electric vehicle 100 are 18 inches in diameter. The circumference (e.g., 2πr, πd) of the wheel is 56.5 inches (8.925×10e-4 miles). Each time the wheel rotates once without slipping, the wheel and the electric vehicle 100 advance 56.5 inches in the direction of rotation of the wheel. If the wheel rotates at 1000 RPM without slipping, the linear speed of the wheel and the speed (e.g., velocity) of the electric vehicle 100 should be about 53.55 mph. If the speed of the electric vehicle 100 is 53.55 mph, but the rotation of the wheel is greater than or less than 1000 RPM, then the wheel is slipping. The greater the difference, the more the wheel is slipping. There are factors that make it so that the linear speed of the wheel may not exactly match the speed of the electric vehicle 100, yet the wheel is not slipping. If the linear speed of the wheel is within an amount (e.g., a factor) of the speed of the electric vehicle 100, then the wheel is not slipping. In an example embodiment, the factor is between 0.1% and 5%. In this example embodiment, slip it may be determined by comparing the speed of the electric vehicle 100 to the linear speed of the wheel. A wheel is locked when the linear speed of the wheel is zero.

### In Operation—Central Control

The diagram of FIG. 9 shows the road 450 as seen from above. The electric vehicle 100 attempts to deaccelerate between the point D0 and beyond the point D2. The road has a right edge 952 and a left edge 954. The surface 452 of the road 450 is dry and provides a high coefficient of friction to the wheels 112 and 132, as discussed above, except for the area between point D1 and point D2 where the wheels 112 and 132 pass over the slick 960. The wheels 122 and 142 are traveling off of the road 450 in the gravel 962 on the shoulder. The response of the drive and traction control system 110 and/or the central brake controller 150 when the wheel 112 passes over the slick 960 is discussed above with respect to FIGS. 4-8. The response of the drive and traction control system 130 and/or the central brake controller 150 when the wheel 132 reaches the slick 960 is the same as with the wheel 112, as discussed above, except that the response is delayed in time. The wheel lock threshold 932 experienced by the wheel 132 and the applied brake force 934 provided by the drive and traction control system 130 and/or the central brake controller 150 are shown in the diagram in the lower left-hand corner of the FIG. 9.

The wheels 122 and 142 travel across the gravel 962 between the distances D0 and D2 and beyond. So, the wheel lock thresholds 922 and 942 for the wheels 122 and 142 respectively stay about the same between the times T0 and T2 and beyond. Because the wheel lock thresholds 922 and 942 remain about the same, the applied brake force 924 and 944 for the wheel 122 and the wheel 142 remain about the same during the period of time T0 to T2 and beyond.

The diagrams of FIG. 9 show that each wheel 112, 122, 132 and/or 142 may encounter different road conditions at different times. The wheel lock thresholds 420, 922, 932 and 942 for the wheels 112, 122, 132 and 142 respectively are different, so a different applied brake force 430, 924, 934 and 944 must be applied to the wheels 112, 122, 132 and 142 respectively so that the force of braking does not cause the electric vehicle 100 to spin. The traction between the wheels 112, 122, 132 and 142 in the road surface 452 is continuously and individually monitored for each wheel 112, 122, 132 and 142 and the desired applied brake force 430, 924, 934 and 944 is applied respectively to maximize braking, yet to prevent or minimize locking of the wheels 112, 122, 132 and 142. Accordingly, the applied brake force for each wheel may need to be adjusted individually.

Drive and traction control systems 110, 120, 130 and 140 individually monitor the slip of wheels 112, 122, 132 and 142 respectively. Information from the sensors 230 from the drive and traction control systems 110, 120, 130 and 140 may be sent to the central brake controller 150 to provide it with a global picture of slip and torsion forces that may result from slip or braking. The central brake controller 150 may also receive more vehicle-wide information from its sensors 160. Using the information from the drive and traction control systems 110, 120, 130 and 140 and from the sensors 160, the central brake controller 150 may detect a loss of traction in one wheel, while the other wheels do not lose traction. As the electric vehicle 100 travels across various surfaces, the slip or lockup of various combinations of wheels may result in a torsion force on the electric vehicle 100 that causes the electric vehicle 100 to spin.

For example, if the wheels 112 and 132 lock up while the wheels 122 and 142 do not, a counterclockwise torsion force, as seen from above the electric vehicle 100, may develop that will cause the electric vehicle 100 to spin (e.g., swerve) to the left. Even if the drive and traction control systems 110, 120, 130 and 140 try to keep their respective wheels from locking up or from only momentarily locking up, the central brake controller 150 can detect when the combination of the performance of the drive and traction control systems 110, 120, 130 and 140 may result in spin. The central braking controller 150 may send data and/or instructions to the various drive and traction control systems 110, 120, 130 and 140 to mitigate, at least in part, circumstances that may result in spin.

### Externally Accessible Reservoir

The electric vehicle 100 further includes a washer fluid system 1000. The washer fluid system 1000 is adapted to hold a liquid (e.g., water, windshield cleaning solution) and to provide the liquid for washing the windshield and/or other windows of the electric vehicle 100. The washer fluid system 1000 may cooperate with the windshield wipers or the rear window wiper to clean the windows of the vehicle.

The washer fluid system 1000 includes reservoir 1010, inlet tube 1020, mount 1030, door 1040, inlet 1050 and an outlet (not shown). The outlet is adapted to be connected to a tube (not shown). The tube is configured to carry the liquid from the reservoir to a window for cleaning the window. The tube is adapted to connect to a nozzle (not shown). The nozzle is adapted to be mounted proximate to the window. The washer fluid system 1000 is configured to provide the liquid to the tube via the outlet at a pressure. The pressure of the fluid forces the fluid through the tube to the nozzle. The pressure on the fluid forces the fluid to flow out the nozzle to be sprayed on the windshield. The washer fluid system 1000 may further include a pump (not shown) to provide the liquid via the outlet at the pressure. The washer fluid system 1000 may be configured to cooperate with a pump provided by the vehicle to provide the liquid via the outlet at the pressure. The pump may be positioned in the reservoir 1010 or outside of the reservoir 1010. The pump is configured to dispense the liquid from the reservoir 1010 via the outlet at a pressure and in such volume that the liquid sprays from the nozzles on the window to be cleaned. The nozzles may distribute the liquid over the area of the window to be cleaned.

The mount 1030 is adapted to be mounted on an inner side of a side panel 1220 of the electric vehicle 100. The mount 1030 is adapted to be positioned with respect to an opening 1230 in the side panel 1220 so that the door 1040 is framed by the opening 1230. The opening 1230 permits the door 1040 to be opened from the outside of the electric vehicle 100 so that the inlet 1050 is accessible from an exterior of the electric vehicle 100.

While the door 1040 is open, the liquid may be poured into the inlet 1050 from the exterior of the electric vehicle 100. The liquid enters the inlet 1050, traverses the inlet tube 1020 and enters into the reservoir 1010. Liquid may be provided via the inlet 1050 until the reservoir 1010, and possibly the inlet tube 1020, are filled with the liquid. The mount 1030 may be sealed around the opening 1230 so that any liquid poured into or around the inlet 1050 will not penetrate between the mount 1030 and the opening 1230 to enter the interior of the vehicle.

The washer fluid system 1000 is configured to cooperate with a controller. The controller is adapted to control the windshield wiper of the window and the delivery of the fluid to the window from the reservoir 1010. The controller may start delivery of the liquid from the reservoir 1010 to the window, start the action of the wiper on the window, cease delivery of the liquid from the reservoir 1010 to the window, and cease the action of the wiper on the window. The washer fluid system 1000 may further include a meter that measures an amount of fluid in the reservoir. The controller may receive data from the meter and report the amount of fluid in the reservoir to a user of the vehicle. The controller may further use data from the meter to inform the user that the reservoir 1010 should be filled. The washer fluid system 1000 may further include a thermometer and a heater in the reservoir 1010. The heater may receive data from a thermometer and turn on the heater to heat the liquid in the reservoir 1010 in the event that it is cold enough to freeze the liquid. The controller may receive the data from the thermometer and control the heater to keep the liquid from freezing.

Because the door 1040 is adapted to provide access to the inlet 1050 from the exterior of the electric vehicle 100, the reservoir 1010 may be filled or checked for fullness manually without opening a hood 1210 of the electric vehicle 100. When the amount of liquid in the reservoir 1010 is reduced, the reservoir 1010 may be refilled by opening the door 1040 and filling the reservoir 1010 from the outside of the electric vehicle 100.

Because the electric vehicle 100 does not include an internal combustion engine, the hood 1210 provides access to an open cavity inside the body of the electric vehicle 100. The cavity is much like the trunk in the back of some conventional vehicles. In fact, the cavity in the front of the electric vehicle 100 is referred to as a front trunk (e.g., frunk). Generally, in conventional vehicles and some electric vehicles, the windshield washing system, including the inlet to the reservoir, is positioned entirely in the engine compartment or the frunk. So, the inlet is accessible only by lifting the hood 1210 to access the inlet 1050. While filling the reservoir positioned in an engine compartment, fluid spills are not of concern because the area around the internal combustion engine is generally not very clean. However, a frunk provides a clean environment for storage and may even be carpeted, so if the reservoir must be accessed for filling via the hood 1210, any spilled liquid would dirty the clean environment of the frunk. So, external access via the door 1040 to the reservoir 1010 keeps the inside of the frunk clean and also provides convenient external access for filling and monitoring the reservoir 1010.

In other words, the washer fluid system 1000 is adapted to be mounted in an internal cavity of the electric vehicle 100 and made accessible from an exterior of the vehicle in such a manner that fluid held in or poured into the washer fluid system 1000 from the exterior of the electric vehicle cannot enter the internal cavity of the electric vehicle 100.

### Afterword

The foregoing description discusses implementations (e.g., embodiments), which may be changed or modified without departing from the scope of the present disclosure as defined in the claims. Examples listed in parentheses may be used in the alternative or in any practical combination. As used in the specification and claims, the words ‘comprising’, ‘comprises’, ‘including’, ‘includes’, ‘having’, and ‘has’ introduce an open-ended statement of component structures and/or functions. In the specification and claims, the words ‘a’ and ‘an’ are used as indefinite articles meaning ‘one or more’. While for the sake of clarity of description, several specific embodiments have been described, the scope of the invention is intended to be measured by the claims as set forth below. In the claims, the term “provided” is used to definitively identify an object that is not a claimed element but an object that performs the function of a workpiece. For example, in the claim “an apparatus for aiming a provided barrel, the apparatus comprising: a housing, the barrel positioned in the housing”, the barrel is not a claimed element of the apparatus, but an object that cooperates with the “housing” of the “apparatus” by being positioned in the “housing”.

The location indicators “herein”, “hereunder”, “above”, “below”, or other word that refer to a location, whether specific or general, in the specification shall be construed to refer to any location in the specification whether the location is before or after the location indicator.

Methods described herein are illustrative examples, and as such are not intended to require or imply that any particular process of any embodiment be performed in the order presented. Words such as “thereafter,” “then,” “next,” etc. are not intended to limit the order of the processes, and these words are instead used to guide the reader through the description of the methods.

What is claimed is:

1. A braking system for an electric vehicle, the braking system comprising:
a friction brake configured to provide a friction brake force;
a traction motor configured provide a traction motor brake force, the friction brake force and the traction motor brake force combine to form an applied brake force to slow a rotation of a wheel of the electric vehicle;
one or more sensors configured to detect at least one of the rotation of the wheel, a speed of the rotation of the wheel, a linear speed of the wheel, a speed of the vehicle and the applied brake force; and
a controller; wherein, the controller is configured to:
use a data detected by the one or more sensors to determine a wheel lock threshold; and
control an operation of the friction brake and an operation of the traction motor to maintain the applied brake force at or below the wheel lock threshold.

2. The braking system of claim 1 wherein the applied brake force comprises a sum of the friction brake force and the traction motor brake force.

3. The braking system of claim 2 wherein the controller controls the operation of the friction brake to reduce the friction brake force to maintain the applied brake force less than or equal to the wheel lock threshold.

4. The braking system of claim 2 wherein the controller controls the operation of the traction motor to reduce the traction motor brake force to maintain the applied brake force less than or equal to the wheel lock threshold.

5. The braking system of claim 1 wherein:
the controller controls the operation of the traction motor to provide the traction motor brake force at a base amount;
the controller controls the operation of the friction brake to provide the friction brake force at a remainder amount;
the base amount is constant; and
the remainder amount is equal to the wheel lock threshold minus the base amount.

6. The braking system of claim 1 wherein:
the controller controls the operation of the friction brake to provide the friction brake force at a base amount;
the controller controls the operation of the traction motor to provide the traction motor brake force at a remainder amount;
the base amount is constant; and
the remainder amount is equal to the wheel lock threshold minus the base amount.

7. The braking system of claim 1 wherein:
while the applied brake force is less than or equal to the wheel lock threshold, the applied brake force slows the rotation of the wheel; and
while the applied brake force is greater than the wheel lock threshold, the applied brake force locks up the wheel.

8. The braking system of claim 1 wherein the wheel lock threshold increases or decreases in accordance with a coefficient of friction of a surface of a road in contact with the wheel.

9. The braking system of claim 6 the wherein the wheel lock threshold is proportional to the coefficient of friction of the surface of the road in contact with the wheel.

10. The braking system of claim 6 the wherein the wheel lock threshold increases as the coefficient of friction of the surface of the road in contact with the wheel increases.

11. The braking system of claim 6 the wherein the wheel lock threshold decreases as the coefficient of friction of the surface of the road in contact with the wheel decreases.

12. The braking system of claim 6 the wherein the traction motor provides the traction motor braking force while the traction motor operates in a regenerative mode.

13. A braking system for an electric vehicle, the braking system comprising:
a friction brake adapted to provide a friction brake force;
a traction motor adapted provide a traction motor brake force, the traction motor adapted to be connected directly to a wheel, the friction brake force and the traction motor brake force combine to form an applied brake force to slow a rotation of the wheel of the electric vehicle, the traction motor is further adapted to detect at least one of the rotation of the wheel, a speed of the rotation of the wheel, a linear speed of the wheel and the applied brake force;
a controller; wherein, the controller is configured to:
use a data detected by the traction motor to determine a wheel lock threshold; and
control an operation of the friction brake and an operation of the traction motor to maintain the applied brake force at or below the wheel lock threshold.

14. The braking system of claim 13 wherein the controller controls the operation of the friction brake to reduce the friction brake force to maintain the applied brake force less than or equal to the wheel lock threshold.

15. The braking system of claim 13 wherein the controller controls the operation of the traction motor to reduce the traction motor brake force to maintain the applied brake force less than or equal to the wheel lock threshold.

16. The braking system of claim 13 wherein:
the controller controls the operation of the traction motor to provide the traction motor brake force at a base amount;
the controller controls the operation of the friction brake to provide the friction brake force at a remainder amount;
the base amount is constant; and
the remainder amount is equal to the wheel lock threshold minus the base amount.

17. The braking system of claim 13 wherein:
the controller controls the operation of the friction brake to provide the friction brake force at a base amount;
the controller controls the operation of the traction motor to provide the traction motor brake force at a remainder amount;
the base amount is constant; and
the remainder amount is equal to the wheel lock threshold minus the base amount.

18. The braking system of claim 13 wherein:
while the applied brake force is less than or equal to the wheel lock threshold, the applied brake force slows the rotation of the wheel; and
while the applied brake force is greater than the wheel lock threshold, the applied brake force locks up the wheel.

19. A braking system for an electric vehicle, the braking system comprising:
a central brake controller;
a first plurality of sensors adapted to detect a torsion force on the electric vehicle, the first plurality of sensors provide a first data to the central brake controller; and
at least two drive and traction control systems, each drive and traction control system configured to determine a wheel lock threshold and to provide an applied brake force in accordance with the wheel lock threshold to slow a rotation of a wheel, each drive and traction control system provides a respective second data to the central brake controller regarding the wheel lock threshold and the applied braking force; wherein:
responsive to the first data identifying the torsion force, the central brake controller analyzes the second data from each drive and traction control system; and
responsive to analyzing the second data, the central brake controller controls the operation of one or more of the at least two drive and traction control systems to reduce the torsion force.

20. The braking system of claim 19 wherein the central brake controller analyzes the second data from each drive and traction control system to detect whether the respective applied brake force is greater than the respective wheel lock threshold.
